(19) United States
(12) Patent Application Publication
(10) Pub. No.: US 2026/0358684 A1
(43) Pub. Date: Nov. 12, 2026

(54) LENS AND MOBILE PHONE LENS KIT

(71) Applicant: TILTA INC., Burbank, CA (US)

(72) Inventors: Sen WU, Shenzhen (CN); Wenping ZENG, Shenzhen (CN); Kefeng ZHOU, Shenzhen (CN)

(21) Appl. No.: 19/673,873

(22) Filed: May 11, 2026

(30) Foreign Application Priority Data
May 11, 2025 (CN) 202520921220.1

(51) Int. Cl. G03B 17/14

(52) U.S. Cl. CPC G03B 17/14

(57) ABSTRACT

Provided herein is a lens, including a lens body and a locking structure. The lens body includes a mounting side and a shooting side, wherein the mounting side is provided with a first bayonet mount for attachment to an external structure. The locking structure is mounted on the lens body and has a locking end, wherein the locking end is configured to protrude from the mounting side of the lens body so as to lock onto the external structure.

### CROSS-REFERENCE TO RELATED APPLICATIONS

The present application for patent claims priority to and the benefit of pending Chinese Application No. 202520921220.1, filed May 11, 2025, and hereby expressly incorporated by reference herein as if fully set forth below in its entirety and for all applicable purposes.

### TECHNICAL FIELD

The present disclosure relates to the technical field of photographic accessories, and more particularly, to a lens and a mobile phone lens kit.

### INTRODUCTION

With the widespread application of photography and videography in daily life, an increasing number of individuals engage in filming during routine activities. Users have developed a preference for recording their daily lives using electronic devices such as mobile phones. Consequently, an expanding array of photographic accessories, including auxiliary lenses, has come into widespread use. However, currently available lenses still exhibit certain drawbacks in terms of user experience, including suboptimal imaging quality and the occurrence of vignetting.

### BRIEF SUMMARY

The present application primarily provides a lens for mobile phones that is capable of reducing the distance between the mobile phone's built-in lens and the auxiliary lens, thereby effectively improving imaging performance and mitigating issues such as vignetting.

To address the aforementioned technical issues, the technical solution provided by the present disclosure is as follows:
A lens, including:
   a lens body, including a mounting side and a shooting side, the mounting side having a first bayonet mount configured for attachment to an external structure; and
   a locking structure, mounted on the lens body and having a locking end, the locking end being configured to protrude from the mounting side of the lens body to lock onto the external structure.

Herein, the locking structure is integrated onto the lens body, whereas only a bayonet mount configuration is provided on the mobile phone case. This arrangement permits the mounting side of the lens body to be positioned closer to the mobile phone's built-in lens, thereby reducing the distance between the mobile phone's built-in lens and the lens body described herein. Moreover, lenses are generally elongated cylindrical structures subject to gravitational forces acting downward, which can readily induce instability in the connection interface provided on the mounting side of the lens body, thereby adversely affecting imaging performance. In the present configuration, the lens body is coupled via the first bayonet mount and the second bayonet mount, and is further secured by the engagement of the locking structure at the locking port to provide additional fastening. Such an arrangement effectively enhances the stability of the lens connection, thereby facilitating consistent and stable imaging.

### BRIEF DESCRIPTION OF THE DRAWINGS

To elucidate the technical solutions presented in the embodiments of the present application or the prior art, the accompanying drawings necessary for describing these embodiments or the prior art will be briefly introduced below. It is apparent that the accompanying drawings described herein represent merely some embodiments of the present application. For those skilled in the art, without the necessity for inventive effort, other drawings can be derived based on the structures depicted in these drawings.

FIG. 1 is a schematic drawing illustrating a mobile phone lens kit herein according to some aspects of the disclosure.

FIG. 2 is an exploded schematic drawing illustrating the mobile phone lens kit herein according to some aspects of the disclosure.

FIG. 3 is a view of a mounting side of the lens body herein according to some aspects of the disclosure.

FIG. 4 is a schematic drawing illustrating a mobile phone case herein according to some aspects of the disclosure.

FIG. 5 is a partially enlarged schematic view of area A in FIG. 4 herein according to some aspects of the disclosure.

FIG. 6 is a schematic diagram of the lens body herein according to some aspects of the disclosure.

FIG. 7 is a partially enlarged schematic view of area B in FIG. 6 herein according to some aspects of the disclosure.

FIG. 8 is a partially enlarged schematic view of area C in FIG. 6 herein according to some aspects of the disclosure.

FIG. 9 is a cross-sectional schematic diagram of the mobile phone lens kit herein according to some aspects of the disclosure.

### Description of Reference Numerals:

100: Mobile phone lens kit;
10: Lens;
20: Mobile phone case;
201: Locking port;
202: Second bayonet mount;
2021: Second mounting piece;
2022: Mounting opening;
2023: Limiting block;
203: Mounting panel;
1: Lens body;
11: First bayonet mount;
111: First mounting piece;
1111: Outer peripheral surface;
1112: First side surface;
1113: Second side surface;
1114: Guiding inclined surface;
12: Shooting side;
13: Mounting side;
14: Washer;
15: Protruding ring;
16: First receiving groove;
161: First stopper wall;
162: Second stopper wall;
17: Second receiving groove;
171: Third stopper wall;
172: Fourth stopper wall;
18: First channel;
19: Alignment mark;
2: Locking structure;
21: Triggering member;
211: First triggering portion;
212: Second triggering portion;
22: Locking member;
221: Locking end;
23: Elastic member.

The objectives, functional characteristics, and advantages of the application will be further elucidated with reference to the embodiments and accompanying drawings.

### DETAILED DESCRIPTION

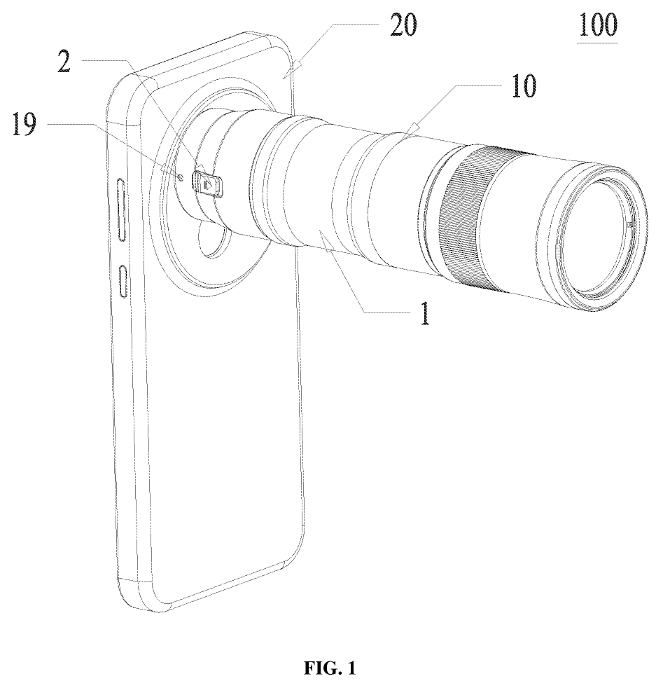

During shooting, when the distance between the lens 10 and the mobile phone's built-in lens is relatively large, it is prone to cause interference and often results in phenomena such as vignetting. Therefore, referring to FIGS. 1-3, provided herein is a mobile phone lens kit 100, including a mobile phone case 20 and a lens 10 for mobile phones. The lens 10 includes a lens body 1 and a first bayonet mount 11 disposed on the lens body 1. The mobile phone case 20 includes a locking port 201 and a second bayonet mount 202. The second bayonet mount 202 includes multiple second mounting pieces 2021, with a mounting opening 2022 defined between adjacent second mounting pieces 2021. The first bayonet mount 11 is configured to be aligned with the mounting opening 2022 and rotated so as to engage with the second bayonet mount 202. Concurrently, a locking structure 2 is provided on the lens body 1, the locking structure 2 having a locking end 221 capable of being secured within the locking port 201. In some aspects, an alignment mark 19 may be provided on the lens body 1, and a corresponding mark may also be provided on the mobile phone case 20. Aligning the alignment mark with the mark on the mobile phone case 20 effectively facilitates the rapid mounting of the lens 10 onto the mobile phone case 20.

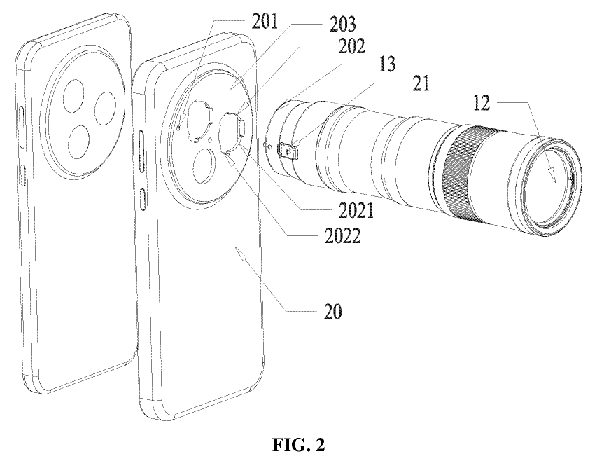

For ease of understanding, referring to FIG. 2, the shooting side of the lens body 1 is defined as the shooting side 12, and the side configured to connect to the mobile phone case 20 is defined as the mounting side 13. The first bayonet mount 11 is disposed on the mounting side 13 for attachment to an external structure, i.e., the mobile phone case 20. In some aspects, the first bayonet mount 11 is mounted onto the second bayonet mount 202 of the mobile phone case 20. The locking structure 2 is mounted on the lens body 1, and the locking end 221 is configured to protrude from the mounting side 13 to facilitate locking engagement with the external structure, i.e., locking onto the mobile phone case 20. In some aspects, the locking end 221 locks into the locking port 201 of the mobile phone case 20, thereby providing further securing force. It can be understood that the external structure may be the mobile phone case 20 itself, or certain structures integrated therewith, such as a lens bracket mounted at the lens region of the mobile phone case 20. Such a lens bracket is considered herein to constitute a part of the structure included in the mobile phone case 20.

Herein, the locking structure 2 is integrated onto the lens body 1, while only a bayonet mount configuration is provided on the mobile phone case 20. This permits the mounting side 13 of the lens body 1 to be positioned closer to the mobile phone's built-in lens 10, thereby reducing the distance between the mobile phone's built-in lens 10 and the lens body 1 described herein. Meanwhile, the lens 10 is generally an elongated cylindrical structure and is subject to downward gravitational force, which can readily induce instability in the connection interface provided on the mounting side 13 of the lens body 1, thereby affecting imaging. The lens body is coupled via the first bayonet mount 11 and the second bayonet mount 202, and is further secured by the engagement of the locking structure 2 within the locking port 201 to provide additional tightening. Such an arrangement effectively enhances the stability of the lens 10 for connection, thereby facilitating stable imaging.

Referring to FIG. 2, the locking structure 2 described is mounted on the lens body 1, and the thickness of the mobile phone case 20 can be relatively thin. For example, the mobile phone case 20 includes a mounting panel 203 at the area corresponding to the built-in lens, and both the second bayonet mount 202 and the locking port 201 are disposed on the mounting panel 203. Herein, the thickness of the mounting panel 203 can range from 1.5 mm to 2.5 mm, for instance, 2 mm. Such a configuration effectively shortens the distance between the mobile phone's built-in lens and the lens body 1 described herein. In some aspects, when the first bayonet mount 11 of the lens body 1 is mounted onto the second bayonet mount 202 of the mobile phone case 20, the distance from the side of the first bayonet mount 11 facing the mobile phone to the mobile phone's built-in lens is ≤ 0.5 mm, for example, 0.3 mm or 0.4 mm. In this manner, it is possible to prevent the first bayonet mount 11 from rubbing against the mobile phone lens during rotation relative to the second bayonet mount 202, while also ensuring that the distance between the mobile phone lens and the lens body 1 is relatively sufficient to ensure good imaging quality for mobile phone photography.

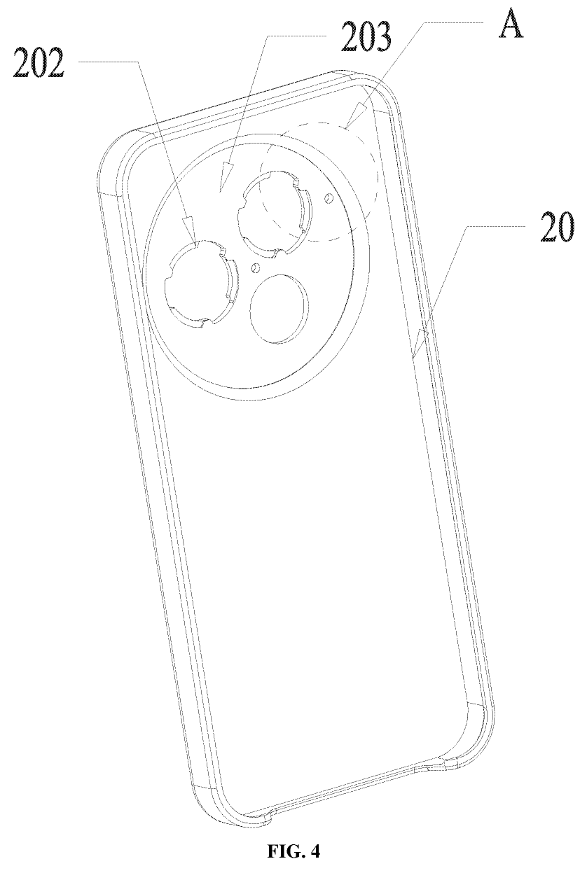

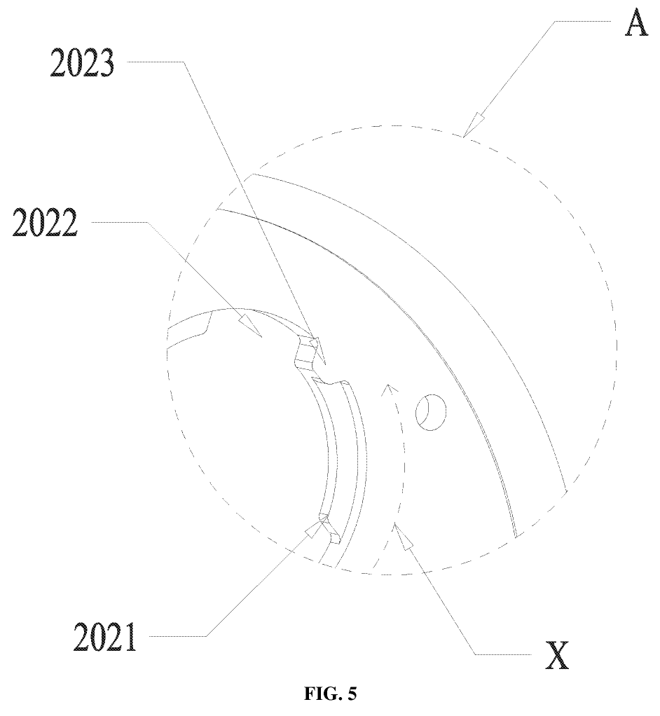

In some aspects, referring to FIGS. 4-5, to facilitate the rotation process between the first bayonet mount 11 and the second bayonet mount 202, a limiting block 2023 is provided at one end of the side of the second bayonet mount 202 facing away from the lens body 1 to restrict the rotation of the first bayonet mount 11. In some aspects, the limiting block 2023 is provided at the end of the side that corresponds to the direction of rotation of the first bayonet mount 11. When the first bayonet mount 11 rotates from the opposite end toward the end featuring the limiting block 2023, the provision of the limiting block 2023 effectively ensures that the first bayonet mount 11 rotates into the correct position, thereby preventing over-rotation of the first bayonet mount 11 which could otherwise result in connection instability. In some aspects,, the rotation direction of the first bayonet mount 11 relative to the side of the second bayonet mount 202 facing away from the lens body 1 is indicated by X in FIG. 5, and the first bayonet mount 11 rotates in this direction to achieve engagement with the second bayonet mount 202.

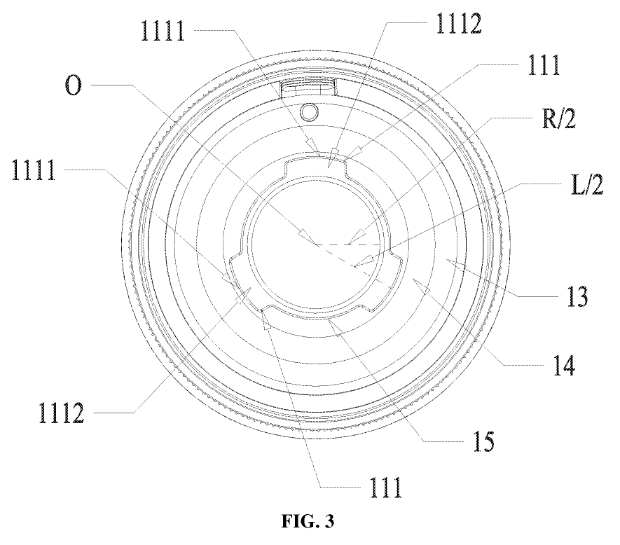

In some aspects, referring to FIG. 3, the first bayonet mount 11 includes a plurality of first mounting pieces 111. The first mounting pieces 111 are configured to be aligned with the mounting openings 2022 defined between two adjacent second mounting pieces 2021 and rotated, thereby effecting engagement between the first bayonet mount 11 and the second bayonet mount 202. In some aspects, the mounting side 13 of the lens body 1 includes a protruding ring 15. At least two first mounting pieces 111 are connected to the protruding ring 15 and extend outward relative to the protruding ring 15, wherein the outer peripheral surfaces of each first mounting piece 111 lie on the same or common circumference. The provision of the protruding ring 15 provides rotational clearance for the movement of the second bayonet mount 202 relative to the first bayonet mount 11. The arrangement of the first mounting pieces 111 extending outward relative to the protruding ring 15 can take the form of outward extensions from the protruding ring 15, as depicted in FIG. 3. The outer peripheral surfaces 1111 of each first mounting piece 111 lie on the same or common circumference.

A washer 14 can also be provided on the mounting side 13 of the lens body 10 to mitigate abrasion between the lens body 10 and the mobile phone case 20.

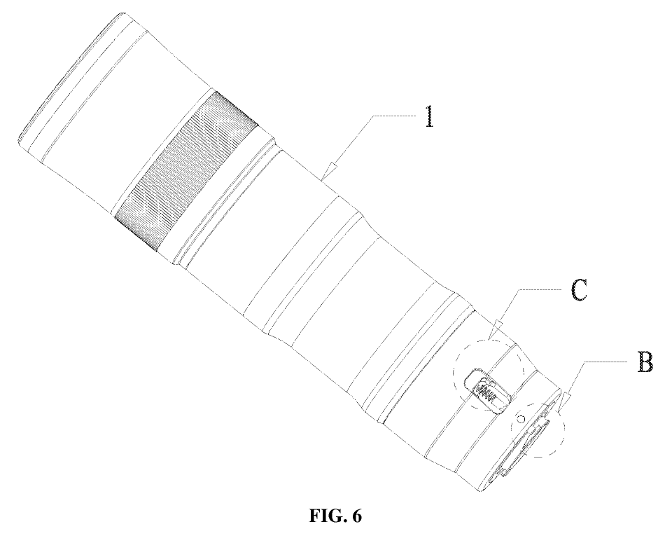

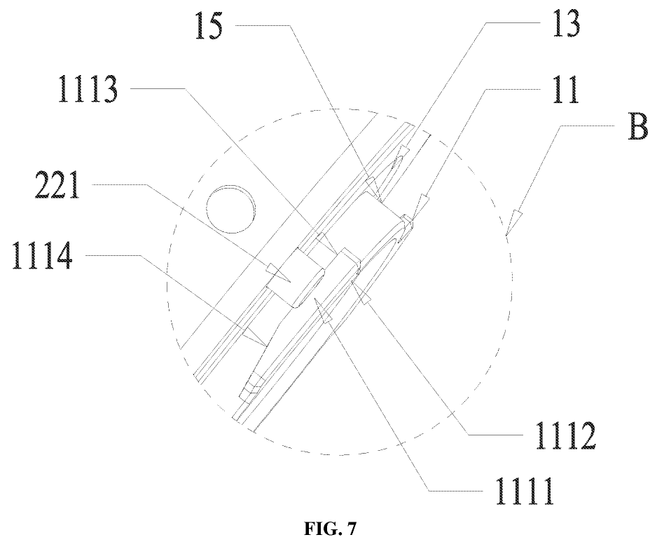

In some aspects, as shown in FIGS. 3, 6 and 7, the first mounting piece 111 includes a first side surface 1112 facing away from the mounting side 13 and a second side surface 1113 facing toward the mounting side 13. The outer peripheral surface 1111 is situated between the first side surface 1112 and the second side surface 1113. A guiding inclined surface 1114 is provided at one end of the second side surface 1113 corresponding to the locking direction of the first mounting piece 111. Such a configuration, wherein the guiding inclined surface 1114 is provided at the end of the second side surface 1113 corresponding to the locking direction of the first mounting piece 111, facilitates the smooth engagement of the first mounting piece 111 with the second mounting piece 2021. The distance between the first side surface 1112 and the mobile phone lens 10 is ≤ 0.5 mm.

Referring to FIG. 3, the lens 10 is typically an elongated cylindrical structure. During mounting, the mounting side 13 of the lens body 1 is attached to the mobile phone case 20, which acts as a connection fulcrum. The shooting side 12 of the lens 10 exerts a generally downward force on this fulcrum, which can readily lead to connection instability. Herein, the inner diameter of the lens body 1 is R, and the outer diameter of the lens body 1 is L. For ease of understanding, the origin O of the inner diameter is indicated in FIG. 3.

Wherein, R ranges from 14.5 mm to 20 mm; and/or L ranges from 20 mm to 28 mm. Such dimensions contribute to relatively stable mounting of the lens body 1, thereby preserving long-term imaging stability. In some aspects, the inner diameter can correspond to the inner diameter of the protruding ring 15, and the outer diameter can correspond to the diameter of the circumference on which the outer peripheral surface 1111 lies.

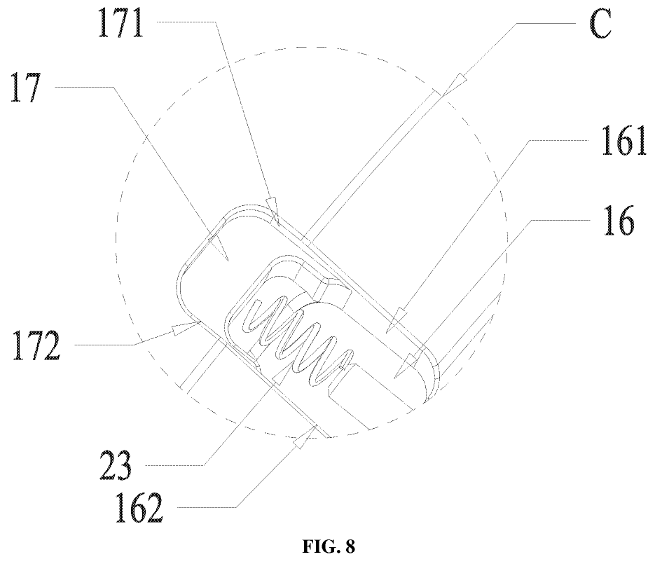

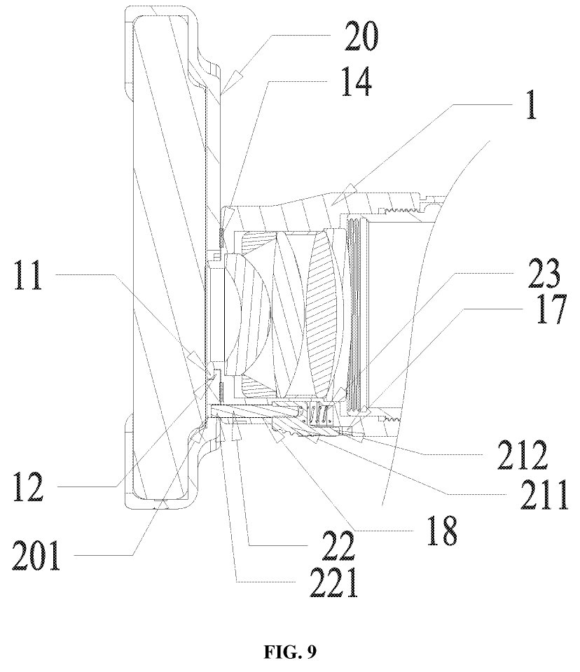

Referring to FIGS. 8-9, the locking structure 2 includes a triggering member 21 and a locking member 22. The triggering member 21 is elastically disposed on the lens body 1 and is connected to the locking member 22. The end of the locking member 22 remote from the triggering member 21 defines the locking end 221. When the triggering member 21 is actuated, the triggering member 21 drives the locking member 22 to retract into the lens body 1; when the triggering action on the locking member 22 is released, the locking member 22 is able to return to its original position. In some aspects, the triggering member 21 being elastically disposed on the lens body 1 encompasses either a direct elastic arrangement or an indirect elastic arrangement. For instance, in some aspects, a spring or analogous resilient element is interposed between the locking member 22 and the lens body 1. Releasing the triggering of the locking member 22 encompasses the scenario wherein a user releases the triggering member 21, causing the triggering member 21 to return to its original position under the influence of elastic force, at which point the triggering action on the locking member is disengaged. In another aspect, it also encompasses the following scenario: when the first bayonet mount 11 is aligned with the mounting opening 2022, the mobile phone case 20 presses against the locking member 22, causing the locking member 22 to retract into the lens body 1. Once the first bayonet mount 11 and the second bayonet mount 202 are properly mounted, the locking member 22 aligns with the locking port 201, whereupon the pressure against the locking member 22 is relieved, thereby allowing the locking member 22 to return to its original position under the influence of elastic force.

Herein, a user can slide the triggering member 21, thereby causing the triggering member 21 to drive the locking member 22 to retract into the lens body 1. The locking end 221 of the locking member 22 can then exit the locking port 201, thereby permitting the first bayonet mount 11 to be rotated relative to the second bayonet mount 202 for disengagement. During mounting, the user can align and rotate the lens; at this stage, the mobile phone case 20 presses the locking end 221 inwardly into the lens body 1. Once the first bayonet mount 11 and the second bayonet mount 202 are fully engaged, the locking member 22 returns to its original position under the influence of elastic force, thereby inserting into the locking port 201.

The locking structure 2 includes an elastic member 23. The lens body 1 includes a first receiving groove 16 and a second receiving groove 17. The triggering member 21 includes a first triggering portion 211 and a second triggering portion 212. At least a portion of the structure of the first triggering portion 211 and the elastic member 23 are accommodated within the first receiving groove, and the elastic member 23 is disposed between a side wall of the first receiving groove 16 and the first triggering portion 211. The second triggering portion 212 is connected to the first triggering portion 211, and at least a portion of its structure is accommodated within the second receiving groove 17. With this arrangement, the first receiving groove 16 and the second receiving groove 17 are configured to both accommodate the triggering member 21 and the elastic member 23, and to limit the movement of the triggering member 21. In some aspects, the two sides of the first receiving groove 16 define a first stopper wall 161 and a second stopper wall 162, and the two sides of the second receiving groove 17 define a third stopper wall 171 and a fourth stopper wall 172. The first triggering portion 211 is accommodated between the first stopper wall 161 and the second stopper wall 162, and the first stopper wall 161 and the second stopper wall 162 serve to limit the movement of the first triggering portion 211. The second triggering portion 212 is accommodated between the third stopper wall 171 and the fourth stopper wall 172, and the third stopper 171 wall and the fourth stopper wall 172 serve to limit the movement of the first triggering portion 211.

The lens body 1 further includes a first channel 18. The first channel 18 is in communication with the first receiving groove 16. The locking member 22 is accommodated within the first channel 18, and at this location, the first channel 18 serves to constrain the axial movement of the locking member 22.

What is claimed is:

1. A lens, comprising:
a lens body comprising a mounting side and a shooting side, wherein the mounting side is configured with a first bayonet mount configured for attachment to an external structure; and
a locking structure is configured to be mounted on the lens body, wherein the locking structure is configured with a locking end configured to protrude from the mounting side of the lens body to lock onto the external structure.

2. The lens according to claim 1, wherein the locking structure comprises a triggering member and a locking member;
wherein the triggering member is configured to be resiliently disposed on the lens body and connected to the locking member;
wherein an end of the locking member distal from the triggering member is provided with the locking end;
wherein the triggering member, upon being actuated, is configured to trigger the locking member to retract toward an interior of the lens body; and
wherein the locking member is configured to return to an original position upon release of actuation of the locking member.

3. The lens according to claim 2, wherein the locking structure further comprises an elastic member;
wherein the lens body comprises one or more first receiving grooves and one or more second receiving grooves;
wherein the triggering member comprises a first triggering portion and a second triggering portion;
wherein at least a portion of the first triggering portion and at least a portion of the elastic member are received in the first receiving groove;
wherein the elastic member is configured to be disposed between a sidewall of the first receiving groove and the first triggering portion;
wherein the second triggering portion is connected to the first triggering portion; and
wherein at least a portion of the second triggering portion is received in the second receiving groove.

4. The lens according to claim 3, wherein the first receiving groove is flanked by a first stopper wall and a second stopper wall;
wherein the second receiving groove is flanked by a third stopper wall and a fourth stopper wall;
wherein the first triggering portion is receivable between the first stopper wall and the second stopper wall; and
wherein the second triggering portion is receivable between the third stopper wall and the fourth stopper wall.

5. The lens according to claim 3, wherein the lens body further comprises a first channel in communication with the first receiving groove, and the locking member is configured to disposed in the first channel.

6. The lens according to claim 1, wherein the first bayonet mount comprises at least two first mounting pieces;
wherein the mounting side of the lens body comprises a protruding ring;
wherein at least two first mounting pieces are connected to the protruding ring and protrude outward relative to the protruding ring; and
wherein an outer peripheral surface of each first mounting piece is configured to be disposed on a common circumference.

7. The lens according to claim 6, wherein each first mounting piece comprises a first side surface facing away from the mounting side and a second side surface facing toward the mounting side;
wherein the outer peripheral surface is located between the first side surface and the second side surface; and
wherein a guiding inclined surface is provided at an end of the second side surface oriented in a locking direction of the first mounting piece.

8. The lens according to claim 6, wherein an inner diameter R of the lens body is from 14.5 mm to 20 mm, and/or an outer diameter L of the lens body is from 20 mm to 28 mm.

9. A mobile phone lens kit, wherein the mobile phone lens kit comprises a mobile phone case configured for mounting on a mobile phone and the lens according to claim 1 configured for photography with the mobile phone;
wherein the mobile phone case comprises a locking port and a second bayonet mount adapted to mate with the first bayonet mount;
wherein the second bayonet mount comprises one or more second mounting pieces with mounting openings defined between adjacent second mounting pieces;
wherein the first bayonet mount is alignable with the mounting openings and rotatable to engage with the second bayonet mount so as to attach the first bayonet mount to the mobile phone case; and
wherein the locking end of the locking structure is lockable into the locking port so as to secure the locking structure to the mobile phone case.

10. The mobile phone lens kit according to claim 9, wherein a limiting block is provided at an end of a side of the second bayonet mount facing away from the lens body, and the limiting block is configured to limit rotation of the first bayonet mount.

11. The mobile phone lens kit according to claim 9, wherein when the lens body is configured to mount on the mobile phone case, a distance from a side of the first bayonet mount facing a lens of the mobile phone to the lens of the mobile phone is ≤ 0.5 mm.

12. The mobile phone lens kit according to claim 9, wherein the mobile phone case comprises a mounting panel;
wherein the second bayonet mount and the locking port are both provided in the mounting panel; and
wherein a thickness of the mounting panel is from 1.5 mm to 2.5 mm.
